(19) United States
(12) Patent Application Publication
(10) Pub. No.: US 2011/0294654 A1
(43) Pub. Date: Dec. 1, 2011

(54) Method of Preparing Plasma-Modified Catalyst

(75) Inventor: How-Ming Lee, Taoyuan County (TW)

(73) Assignee: ATOMIC ENERGY COUNCIL-INSTITUTE OF NUCLEAR ENERGY RESEARCH, Taoyuan County (TW)

(21) Appl. No.: 12/788,717

(22) Filed: May 27, 2010

(51) Int. Cl. B01J 37/34

(52) U.S. Cl. 502/5

(57) ABSTRACT

A method for making a catalyst is provided. A plasma treatment is inserted between drying process and calcination process. By using a plasma, not only the species and materials in the gas-phase can reacted and inserted into the catalyst, but also the species and materials on the catalyst surface can be modified and removed from the catalyst. The plasma process can thus alter catalyst characteristics, increase products' selectivity, and enhance catalytic activity.

### TECHNICAL FIELD OF THE DISCLOSURE

The present disclosure relates to preparing a catalyst and, more particularly, to processing a catalyst with plasma for enhancing catalyst's characteristics before calcination during catalyst preparation.

### DESCRIPTION OF THE RELATED ART

A variety of methods have been used to prepare catalysts, e.g., impregnation, ion exchange, settling/sedimentation, sol-gel and coprecipitation. Regarding coprecipitation, it comprises steps of precipitation, washing, filtering (or centrifuging), drying, calcination and reduction. Temperature, pH value, ion concentration, titration process and titration velocity during the coprecipitation all influence the catalytic activity. The following processes of drying, calcination and reduction also play great roles in catalytic characteristics, e.g., crystal dispersion, specific surface area, catalytic activity, and stability. A catalyst is usually prepared under high temperatures, generally lowering the specific surface area and catalytic activity, where no plasma process is introduced for preparing catalysts. Hence, the prior art does not fulfill all users' requests on actual use.

### SUMMARY OF THE DISCLOSURE

The main purpose of the present disclosure is to process a catalyst with plasma for enhancing catalyst's characteristics before calcination during catalyst preparation.

To achieve the above purpose, the present disclosure is a method of fabricating a plasma-modified catalyst, comprising steps of: (a) dropping a metal salts solution and a sodium carbonate (Na₂CO₃) solution into de-ionized water for being fully mixed to obtain a mixed solution; (b) processing the mixed solution through aging and cooling the mixed solution down to obtain a slurry-like solution; (c) processing the slurry-like solution through solid-liquid separation to obtain precipitates and, after washing the precipitates with de-ionized water for several times, drying the collected precipitates to obtain catalyst powders; (d) treating the catalyst powder in a plasma reactor with specific gases; and (e) calcining the catalyst powder. Accordingly, a novel method of preparing a plasma-modified catalyst is obtained.

### BRIEF DESCRIPTIONS OF THE DRAWINGS

The present disclosure will be better understood from the following detailed description of the preferred embodiment according to the present disclosure, taken in conjunction with the accompanying drawings, in which

FIG. 1 is the flow view showing the preferred embodiment according to the present disclosure;

FIG. 2 is the view showing the methanol selectivity; and

FIG. 3 is the view showing the methanol yield.

### DESCRIPTION OF THE PREFERRED EMBODIMENT

The following description of the preferred embodiment is provided to understand the features and the structures of the present disclosure.

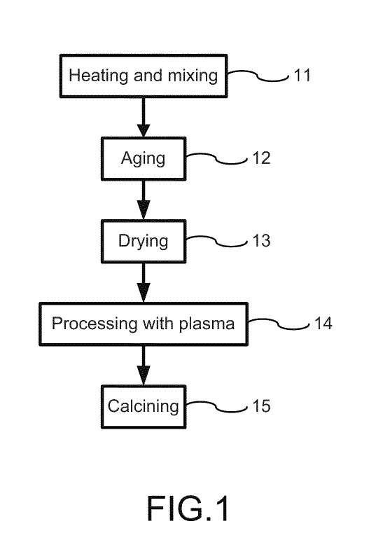

Please refer to FIG. 1, which is a flow view showing a preferred embodiment according to the present disclosure. As shown in the figure, the present disclosure is a method of preparing a plasma-modified catalyst, where plasma is introduced between drying and calcination on preparing a catalyst to modify the catalyst. The present disclosure comprises the following steps:

(a) Heating and mixing 11: A metal salts solution and a sodium carbonate (Na₂CO₃) solution are dropped into de-ionized water to be fully mixed at a controlled titration velocity, where the metal salts solution is made with copper nitrate, zinc nitrate and aluminum nitrate; and the Na₂CO₃ solution is used as a buffer agent. The solution is heated at a temperature between 40° C. and 90° C. and has a pH value controlled between 6.8 and 9.5.

(b) Aging 12: The mixed solution is processed through aging and then is cooled down to form a slurry-like solution. This step of aging in some circumstances can be omitted.

(c) Drying 13: The slurry-like solution is processed through solid-liquid separation to obtain precipitates. After washing the precipitates with de-ionized water for several times, the collected precipitates are dried to obtain catalyst powders.

(d) Processing with plasma 14: The catalyst powders are put into a plasma reactor with specific gases flown into the plasma reactor to modify the catalyst powders with plasmas, where the specific gases contain oxygen, hydrogen, nitrogen, noble gases, and/or a mixture of previous gases; and the plasma gas in the plasma reactor has a pressure between 0.01 and 1.0 MPa.

(e) Calcining 15: The catalyst powders are then taken out to be heated to a specific temperature for calcination to obtain a plasma-modified catalyst. This step of calcination in some circumstances can be omitted.

Thus, a novel method of preparing a plasma-modified catalyst is obtained.

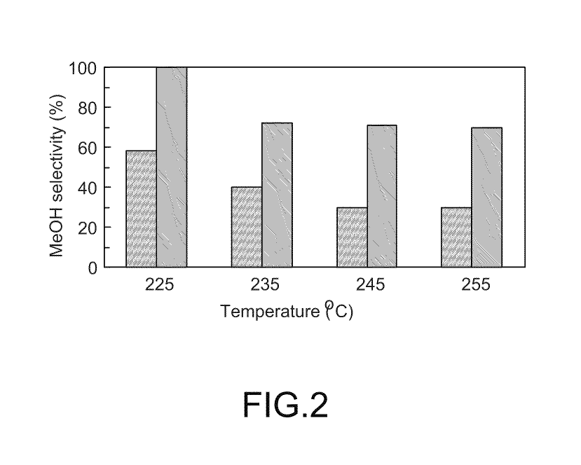

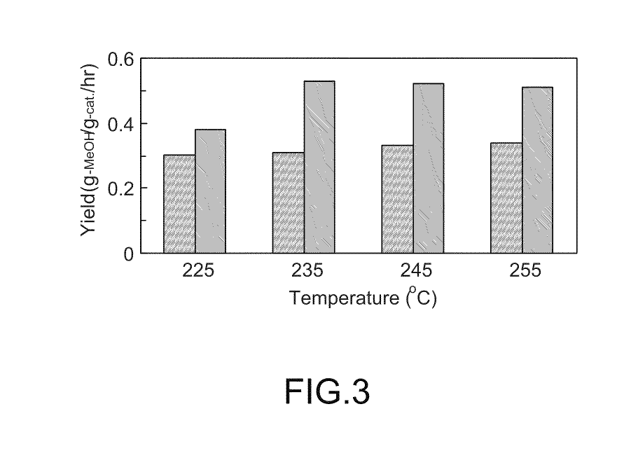

Please refer to FIG. 2 and FIG. 3, which are views showing the methanol selectivity and the methanol yield, respectively. As shown in the figures, under different temperatures, hydrogen (H₂), CO and N₂ are flown in, whose molar concentration is 64%:32%:4%; and, then, 3 grams of catalyst is added for reaction under 4.0 MPa at a gas hourly space velocity (GHSV) of 18000 ml/g·h.

In FIG. 2, it shows that the methanol selectivity of a plasma-modified catalyst prepared according to the present disclosure is better than that of a non-modified catalyst. In FIG. 3, it shows that a methanol yield of a plasma-modified catalyst prepared according to the present disclosure is higher than that of a non-modified catalyst. Conclusively, the plasma-modified catalyst prepared according to the present disclosure has better performances than the non-modified catalyst.

To sum up, the present disclosure is a method of preparing a plasma-modified catalyst, where a plasma process is inserted between drying and calcination to enhance the methanol selectivity and the catalytic activity by interactions of the catalyst materials with the chemically active species of plasmas.

The preferred embodiment herein disclosed is not intended to unnecessarily limit the scope of the disclosure. Therefore, simple modifications or variations belonging to the equivalent of the scope of the claims and the instructions disclosed herein for a patent are all within the scope of the present disclosure.

What is claimed is:

1. A method of preparing a plasma-modified catalyst, the method comprising:
mixing a metal salts solution and a sodium carbonate (Na₂CO₃) solution into de-ionized water to be fully mixed while being heated to obtain a mixed solution;
processing said mixed solution through aging and cooling said mixed solution down to obtain a slurry-like solution;
processing said slurry-like solution through solid-liquid separation to obtain precipitates;
after washing said precipitates with de-ionized water for several times, drying said precipitated to obtain catalyst powders;
putting said catalyst powders into a plasma reactor with a specific gas to process said catalyst powders with a plasma; and
heating said catalyst powders to a specific temperature to process calcination.

2. The method according to claim 1, wherein, in mixing the metal salts solution and the Na₂CO₃ solution into the de-ionized water, said metal salts solution is obtained with copper nitrate, zinc nitrate and aluminum nitrate.

3. The method according to claim 1, wherein, in mixing the metal salts solution and the Na₂CO₃ solution into the de-ionized water, said mixed solution is heated under control at a temperature between 40° C. and 90° C.

4. The method according to claim 1, wherein, in mixing the metal salts solution and the Na₂CO₃ solution into the de-ionized water, a pH value of said mixed solution controlled between 6.8 and 9.5.

5. The method according to claim 1, wherein, in putting said catalyst powders into said plasma reactor with said specific gas, said specific gas contains oxygen, hydrogen, nitrogen, noble gases, and/or a mixture of previous gases.

6. The method according to claim 1, wherein, in putting said catalyst powders into said plasma reactor with said specific gas, said specific gas in said plasma reactor has a pressure between 0.01 and 1.0 MPa.
